(19) United States
(12) Patent Application Publication
(10) Pub. No.: US 2004/0195845 A1
(43) Pub. Date: Oct. 7, 2004

(54) Latch arrangement

(76) Inventor: John Phillip Chevalier, London (GB)

Correspondence Address: STETINA BRUNDA GARRED & BRUCKER, 75 ENTERPRISE, SUITE 250, ALISO VIEJO, CA, 92656, US

(21) Appl. No.: 10/482,903

(22) PCT Filed: Jul. 1, 2002
(86) PCT No.: PCT/GB02/03026

(30) Foreign Application Priority Data
Jul. 4, 2001 (GB) 0116285.8

(51) Int. Cl. E05C 3/06

(52) U.S. Cl. 292/201

(57) ABSTRACT

A latch arrangement (100) for an automotive door or other closure manually operable by actuators external to the latch, comprising: a latch; an electric motor (34) controlled by an electronic control unit (7) selectively to release the latch and to lock and unlock the latch; and internal actuators (700, 800) connectable in use mechanically to the external manual actuators and arranged to release the latch and/or to lock and unlock the latch; the electronic control unit (7) being responsive to the initial movement of one of the external manual actuators to both unlock and release the latch so as to open the door or other closure electrically using the electric motor (34). Further, a latch arrangement (100) for an automotive door or other closure manually operable by manual controls external to the latch arrangement (100) a locking or superlocking electric switch or sensor (11) connected electrically to the electronic control unit (7).

The invention relates to latch arrangements for closures such as automotive doors and tailgate locks, and is particularly, although not exclusively, useful with electronic central locking systems for vehicles and electronic management circuitry for other closures.

The use of a remote transponder or transmitter, for example on a key fob, to lock and unlock car doors is of course well-known. The car has an integrated transponder and antenna, powered by the car battery, and an electronic control system which receives an encoded signal from the remote transmitter, checks it for authenticity, and then initiates the specified function such as locking or unlocking of the vehicle doors, using, for example, electric motors. Such control systems are typically heavy consumers of electric power, because the transponder is powered on continuously. It is the purpose of one of the inventions to overcome this problem of power consumption, although this invention is useful even where a transponder system is not included.

Accordingly, a first invention provides a latch arrangement for an automotive door or other closure manually operable by actuators external to the latch, comprising:

a latch; an electric motor controlled by an electronic control unit selectively to release the latch and to lock and unlock the latch; and internal actuators connectable in use mechanically to the external manual actuators and arranged to release the latch and/or to lock and unlock the latch; the electronic control unit being responsive to the initial movement of one of the external manual actuators to both unlock and release the latch so as to open the door or other closure electrically using the electric motor.

Since door unlocking is only required to have been done immediately prior to door opening, the invention allows electric unlocking to be performed at the last allowable moment. In the case that a transponder system is used, this has the advantage that the transponder need only be activated immediately prior to door opening, when the handle is manually operated. At other times, the transponder can be powered off, saving the drainage on the car battery, and moreover allowing the transponder to draw substantially greater power since it is on for a very short time. Since the distance between the transmitter and transponder is very small a much smaller transmitter is required, which in turn allows the transmitter to have substantially lower power, so that the remote controller battery lasts longer or allows for a smaller power supply (battery). Alternatively, it allows an alternative form of portable electronic key to be used, which may not necessarily require an electric power supply (a so-called passive transmitter, which normally obtains its power from the signal being emitted by the transponder).

Preferably, the electronic control unit is responsive to a release signal from a transponder to allow the said electrical unlocking and release of the latch, but otherwise to prevent it.

It is desirable to be able to lock or superlock the car doors electrically, and in my patent publication No. WO98/27301 I disclose arrangements for achieving this using a single electric motor in each latch. Superlocking, or double locking or deadlocking as it is also sometimes called, involves neutralising all possible manual control means except for the key mechanism for extra security. Typically then the car doors could only be unlocked by an electronic remote controller or else by a key in the driver's door. In this way, even if a thief breaks a car window in order to operate the door knob or the interior door handle, the superlocking prevents the doors from being unlocked.

The purpose of a second invention is to allow locking or superlocking to be initiated electrically from inside the vehicle in such a way that the operator can then exit the vehicle and shut the door. Accordingly, the second invention provides a latch arrangement for an automotive door or other closure manually operable by manual controls external to the latch arrangement, comprising:

a latch; an electric motor controlled by an electronic control unit selectively to release the latch and to lock and unlock the latch; a locking or superlocking electric switch or sensor connected electrically to the electronic control unit; and a switch or a sensor responsive to the latch position to send a latch signal to the electronic control unit; the electronic control unit being responsive to the latch signal being indicative of the door or other closure being at least partly closed, and to the operation of the locking or superlocking switch, to lock or superlock the latch electrically, preventing latch release by at least one of the external manual controls.

Using the second invention, the car door locks can be locked or superlocked centrally and electrically by the user first operating the superlocking switch which may be inside the car, then leaving the car and shutting the door or doors, the locking or superlocking only being effective once the doors are at least partly closed. This invention is particularly useful where the latch arrangement is responsive to partial closure of the door or other closure to complete its closure, using the same electric motor, as disclosed in WO98/27301.

In order that the inventions may be better understood, a preferred embodiment of both inventions will now be described, by way of example only, with reference to the accompanying diagrammatic drawings, in which:

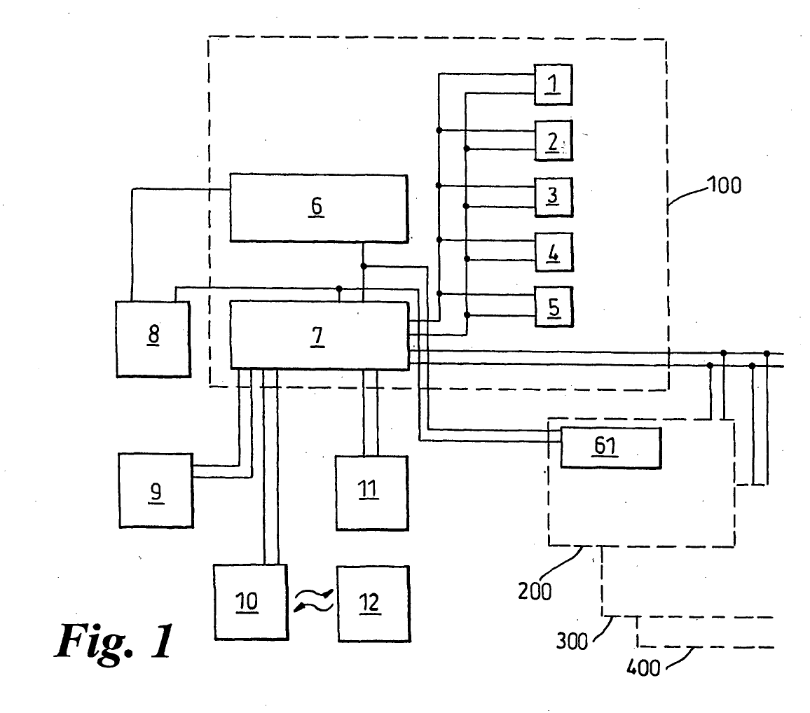

FIG. 1 is a schematic block diagram of a car central locking system embodying both inventions;

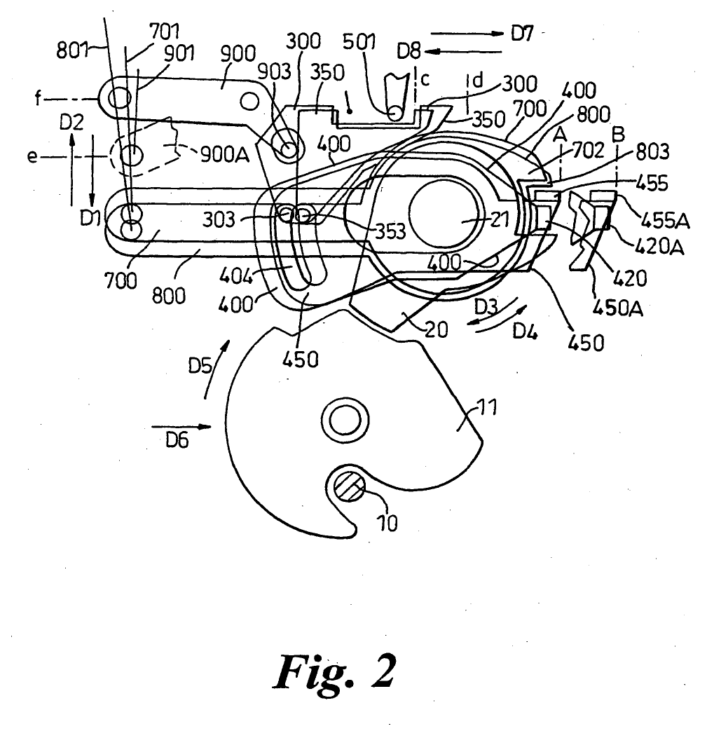

FIG. 2 is identical to FIG. 26 of WO98/27301 and shows a latch arrangement for the selective electrical locking of a door with two door handle mechanisms and an interior door knob, capable of use with the inventions; and

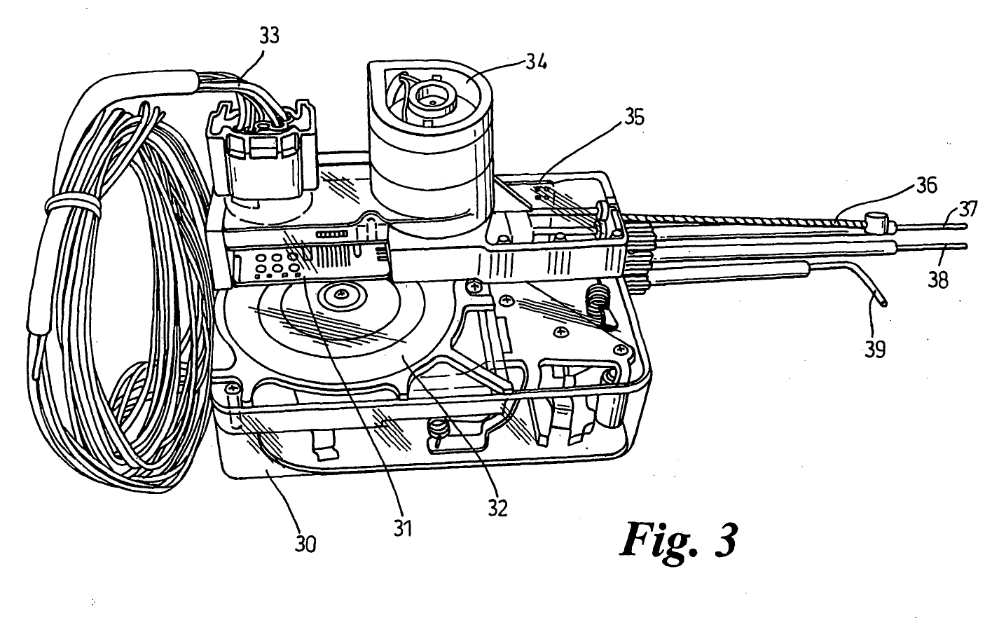

FIG. 3 is a perspective view of a car door latch arrangement embodying both inventions; and

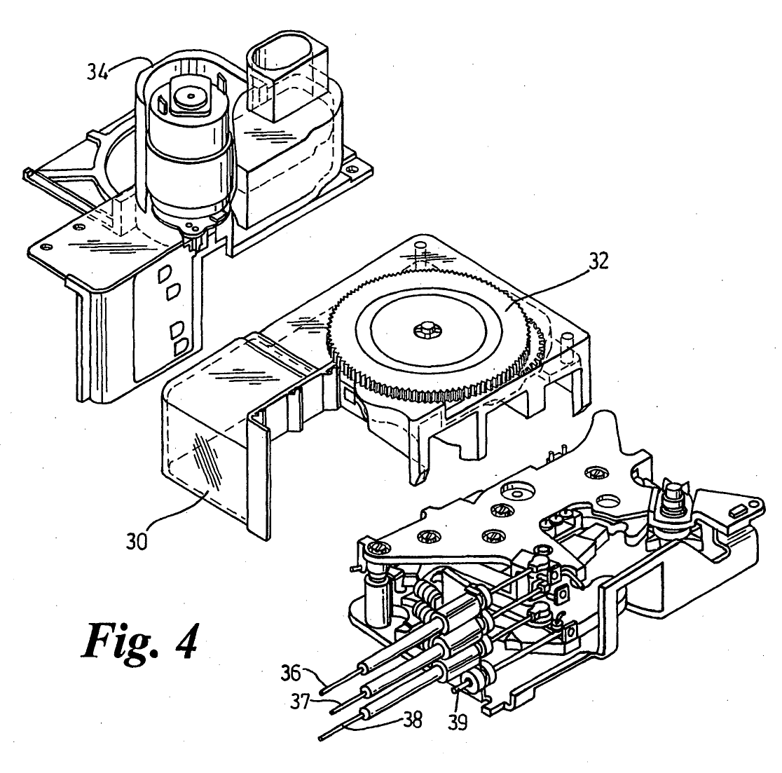

FIG. 4 is an exploded perspective view of an arrangement corresponding to FIG. 3 but with a modified construction.

In this example, a car is fitted on each door with a latch arrangement, which controls all aspects of the opening and locking of that door, both electrically and mechanically manually. Such an arrangement is disclosed in my patent publication No. WO98/27301, referred to above, and only parts of that specification will be repeated here. A schematic block diagram is shown in FIG. 1; part of the mechanical arrangement within each latch arrangement is shown in FIG. 2; and a complete prototype latch arrangement is shown in FIG. 3, which is a perspective view of the latch arrangement complete with its external manual actuator cables and electrical wiring.

With reference to FIG. 1, a latch arrangement 100, configured as a master latch, is arranged to co-operate with slave latch arrangements 200, 300 and 400, through electrical wire connections within the vehicle. Hall-effect position sensors 1 to 5 (or any suitable switch or position sensor) act as electrical switches and are each connected to an electronic control unit 7 which comprises a microprocessor. The control unit 7 supplies electrical drive signals to a motor drive and position sensor unit 6, and a circuit breaker 8, associated with the vehicle speedometer or hand brake, interrupts the power supply when the vehicle is in motion or as may be arranged. The electric motor drives the mechanical components of the latch arrangement through an indexing output drive disc 32, FIG. 3, and a Hall-effect sensor (not shown) detects the rotary position of that disc 32 and provides a corresponding digital or analogue indexing signal to the electronic control unit 7 as the disc rotates.

A power supply 9, taken from the car battery, drives the electronic control unit 7 and supplies all the necessary electric power for the latch arrangement. The electronic control unit 7 is also connected to a transponder unit 10 with its associated antenna, which is in radio communication with a portable remote control device 12, which includes a transmitter and antenna. The remote control device 12 may be passive or tactile in operation, i.e. it may or may not contain a switch for its operation and may or may not by powered by a dedicated power supply (battery).

The transponder antenna is shielded (not shown) by an appropriate ferromagnetic or electromagnetic shielding on at least one side so that it cannot receive spurious transmissions from within the vehicle, and responds solely to genuine transmissions from the remote control device 12 when that is within range. The remote control device 12 need not have an internal power supply, if it passively responds to transmissions from the transponder 10 to return an appropriate signal to the transponder, for example at a characteristic frequency. A typical operating range would be within 1 metre, such that a holder of the device 12 is necessarily within range of the transponder 10 when operating the door handle on the car.

A locking or superlocking switch or sensor 11 is mounted on a car door or dashboard or elsewhere in the interior, to initiate the specified locking, be it simple locking or superlocking of all the car door latches, and is wired to the electronic control unit 7.

The master latch arrangement 100 has the configuration and the connections to external units as described above, but each slave arrangement 200, 300, 400 etc. has its corresponding motor drive and position sensor 61 powered through the circuit breaker 8 but need not be connected to the power supply 9, the transponder 10 or the superlocking switch/sensor 11. The operation of the door latches is under a distributed electronic control in this way, with one master and several slaves. It is particularly advantageous that every electronic control unit and every Hall-effect sensor is contained wholly within a monoblock housing, as shown in FIG. 3, as this minimises the necessary wiring within the vehicle, and dramatically decreases the number of components and the weight of the vehicle.

As shown in FIG. 3, the monoblock housing 30 accommodates the electric motor 34 (shown as the motor drive 6 in FIG. 1); a printed circuit board 35 including five Hall-effect position sensor switches (1 to 5 of FIG. 1); a pair of printed circuit boards 31 comprising the electronic control unit 7 and the position sensor associated with the motor drive indexing disc 32; and the mechanical levers and actuators of the latch, arranged pivotally within the housing 30, part of which arrangement is shown as an example in FIG. 2. The exterior door handle is connected in use to a cable 36, corresponding to cable 801 of FIG. 2, which operates an actuator 800 in FIG. 2. The first stage of manual operation of that exterior door handle brings the cable 36 to such a position within the housing 30 that the magnet (not shown) it carries has moved into register with the first Hall-effect sensor 1, which sends an appropriate signal to the electronic control unit 7. Correspondingly, the interior door handle is connected through cable 37 (or 701 in FIG. 2) to actuator 700, and the position of the handle is similarly detected by the second Hall-effect sensor 2. Although this second sensor is provided, it is not essential for use in the preferred embodiment, and will not be described below. The lock control door knob, which is a two-position knob arranged on the door sill, is connected through cable 38 (901 in FIG. 2) to a corresponding actuator 900A in FIG. 2, whose position is sensed by a third Hall-effect sensor 3. A door key mechanism for the driver's door is connected through cable 39 and through corresponding actuators (not shown in FIG. 2) to control appropriately the movement of actuators 300, 350 (FIG. 2), and its position is sensed by a fourth Hall-effect sensor 4.

A latch bolt 11 (FIG. 2), sometimes referred to as a claw, is positioned pivotally adjacent an opening in the housing 30 (not shown, at the rear of the housing as shown in FIG. 3), and its rotary position is sensed by a fifth Hall-effect sensor 5 on the same printed circuit board 35 of FIG. 3, such that the electronic control unit 7 is able to determine whether the door is at least partly closed.

Printed circuit board 31 includes a sixth Hall-effect sensor, which responds to a magnet mounted for rotation on the indexing disc 32 so as to indicate its position. In this example, a regular series of several magnets is angularly disposed on the disc 32, to provide digital or analogue indexing through the Hall-effect sensor, so that the pulses (or variations on the magnetic field intensity of the ring magnet) from the sensor are provided to the electronic control unit 7 to record, within a predetermined angular range of accuracy, the angular position of the indexing disc 32.

As described more fully in WO98/27301, a striker, in the form of a cylindrical bar 10, FIG. 2, is fixed vertically in each door frame. The door latch arrangement 30 is bolted to the door such that the latch bolt 11 engages the striker to hold the door in its closed position. A latching pawl 20 engages an edge of the latch bolt 11 in order selectively to latch it fully or to partly latch it, in a conventional manner. The pawl is rotated under the control of various coupling members which are linked respectively to the exterior and interior handles, the key cylinder (where provided) and either the interior door knob or the mechanical child safety lock control (where provided). The electric motor is controlled to operate the pawl to release the latch bolt, for electrical door opening. It is also controlled selectively to couple the exterior handles and knobs to operate the pawl appropriately.

Two pawl release levers 700, 800 are connected to the external manual controls, in this example the interior and exterior door handles, and each of these levers pivots on the same axis 21 as the pawl 20. Each pawl release lever is selectively coupled to the pawl 20 by its own rotary coupling member 300, 400 and 350, 450 respectively. Each such rotary coupling member comprises a locking member 300, 350 connected respectively to a rotary sliding member 400, 450, all disposed around the common pivot axis 21 providing maximum compactness and simplicity, and enabling the pawl release levers to have sufficient leverage over the pawl to be accommodated within the housing. This is described in WO98/27301.

In addition, each latch arrangement has a further lever 900 connected to an external control mechanism through a cable 901, which could be used for child safety switching, but in this example is connected to an interior door knob because it is used in a front door. This further lever 900 has a pivot point within the housing, and is connected to a lever arm with an end pin 903 coupling with an appropriate one of the rotary coupling members.

The locking members 300 and 350 have respective projecting pins which engage with a cam pin on the rotary indexing and driving disc 32 (not shown). The locking members may be driven together, to reciprocate in the directions D7 and D8. The detailed operation of the mechanical arrangement of FIG. 2 will be apparent from a reading of WO98/27301, and will not be described here because it is not essential to an understanding of the inventions. FIG. 2 corresponds to FIG. 26 of WO98/27301.

A typical cylindrical key mechanism for the car door has a rotary output, which is converted to linear displacements of the locking members 300, 350 of FIG. 2, for example using the cam disc arrangement described in WO98/27301. This provides for overriding mechanical operation of the lock. In fact every electrical operation in the latch has a corresponding mechanical override.

To assist in understanding the structure, an exploded view of an essentially similar monoblock assembly is shown in FIG. 4, in which corresponding parts have the same reference numerals.

The operation of the preferred embodiment of the inventions will now be described with reference to FIG. 1 in particular.

If the vehicle is moving, then the circuit breaker 8 prevents power reaching the latch arrangements, and the doors (latches) will revert to conventional manual operating mode, i.e. the doors can be opened manually mechanically if desired and without any involvement of the electric drive mechanism. Once the vehicle is stationary with the speedometer at zero or any specified speed, then the circuit breaker 8 will close; alternatively, if the circuit breaker 8 is responsive to the position of the handbrake, then the circuit breaker will close once the handbrake is on. This then activates the electronic control for all the latch arrangements. Assuming the occupants wish to superlock the car once they have left it, the driver has two options: either to press the superlocking switch 11, or to activate the remote control device 12. If he presses the superlocking switch 11 whilst still in the car or reaching into the car from just outside the door, then the electronic control unit 7 will be initiated, and will superlock the car doors as soon as the respective doors have been closed, or moved at least to the partly latched position. Operation of the remote controller is then not necessary.

Alternatively, the driver may superlock the car, once he has left the car and shut the doors, by activating the remote control device 12.

Re-entry to the car may be gained either by further operation of the remote control device 12, or by insertion and operation of the key in the driver's door. Operation with the remote control device 12 will now be described:

It is necessary for the operator to bring the remote control unit, which may be active or passive, within range of the fixed onboard transponder 10, such that the transponder receives and recognises an identifying signal. At this stage, however, the transponder 10 is not powered on. The operator then turns the exterior door handle and moves it to an intermediate position so as to activate the sensor switch 1, to awaken the electronic control unit 7 and power on the transponder 10. Provided the remote control device 12 is still within range, the electronic control unit 7 recognises the corresponding signal from the transponder 10 and unlocks the driver's door latch and, through the master-slave connections, unlocks all the other door latches as well or as may be specified. The electronic control unit 7 then immediately opens the door, in this case the driver's door. There is no need then for the door to be opened mechanically, by the continued pulling of the exterior door handle. Less force is therefore required by the operator to open the door. However, there is still the mechanical override, should the electronic system fail to open the door electrically.

It is probable that there would be only one key mechanism, fitted to the driver's door. However, there could be more than one door latch operable by a remote control device, by one of the slave latch arrangements. In this case, a passenger could bring his remote control device 12 into range whilst operating the external manual actuator (control means), be it a knob or a pull or push handle of a side or rear door (boot or tailgate), initiating electric door unlocking and door opening in sequence.

It is anticipated that cars in future may have no mechanical key at all, in which case it is probable that there would need to be a back-up electric power supply, possibly rechargeable, to ensure the safe operation of unlocking and locking of the doors.

One example of a remote control device 12 could be a “smart card” transmitting for example a 138 kHz signal.

The electronic control unit 7 is preferably programmed such that it records whether the driver's door had been unlocked by the key, instead of by the remote control device, in which case it would ensure that the key is used when it is re-locked.

In the preferred example, the magnets for operating the Hall-effect sensors are carried by the manual control cable end connectors, which connect the corresponding manual control cables 36 to 39 to the appropriate actuators within the housing 30. In the rest position, the magnets are close to the Hall-effect sensors, and each sensor is “on”, drawing a small TTL current.

1. A latch arrangement for an automotive door or other closure manually operable by actuators external to the latch, comprising:
a latch; an electric motor controlled by an electronic control unit selectively to release the latch and to lock and unlock the latch; and internal actuators connectable in use mechanically to the external manual actuators and arranged to release the latch and/or to lock and unlock the latch; the electronic control unit being responsive to the initial movement of one of the external manual actuators to both unlock and release the latch so as to open the door or other closure electrically using the electric motor.

2. A latch arrangement according to claim 1, in which the electronic control unit is responsive to a release signal from a transponder to allow the said electrical unlocking and release of the latch, but otherwise to prevent it.

3. A latch arrangement according to claim 1 or 2, in which the electronic control unit is housed within the latch arrangement.

4. A latch arrangement according to any preceding claim, comprising sensors within the latch arrangement responsive to the positions of the actuators to provide corresponding signals to the electronic control unit.

5. A latch arrangement according to claim 4, in which the sensors are Hall effect sensors.

6. Closure control apparatus comprising a latch arrangement according to claim 2 or to claims 3, 4 or 5 as dependent on claim 2, and a transponder coupled to an antenna responsive to a transmitted security signal to provide the release signal.

7. Closure control apparatus according to claim 6, in which the transponder is inactive, to minimise power consumption, unless activated by the electronic control unit in response to the sensed movement of the external actuator.

8. Closure control apparatus according to claim 6 or 7, in which the transponder antenna is shielded electromagnetically from at least one side to prevent reception of spurious signals from a motor vehicle or other body incorporating the latch arrangement in use.

9. A latch arrangement or closure control apparatus according to any preceding claim for a motor vehicle, comprising a circuit breaker responsive to a signal from the hand brake or speedometer or otherwise representative of movement of the vehicle to interrupt the power supply to the electric motor, to avoid inadvertent door opening by anomalous operation of the electronic control unit when the vehicle is in motion.

10. A latch arrangement or closure control apparatus according to any preceding claim, in which the electronic control unit is arranged to communicate with at least one other similar unit in a similar latch arrangement, to provide central locking, in a vehicle or other body incorporating the latch arrangements, with distributed electronic control.

11. A latch arrangement or closure control apparatus according to claim 10, in which the electronic control unit is adapted to act selectively as a master or a slave, such that a master electronic control unit controls the or each slave electronic control unit to release the corresponding latch and to lock and unlock the corresponding latch.

12. A latch arrangement for an automotive door or other closure manually operable by manual controls external to the latch arrangement, comprising:
a latch; an electric motor controlled by an electronic control unit selectively to release the latch and to lock and unlock the latch; a locking or superlocking electric switch or sensor connected electrically to the electronic control unit; and a switch or sensor responsive to the latch position to send a latch signal to the electronic control unit; the electronic control unit being responsive to the latch signal being indicative of the door or other closure being at least partly closed, and to the operation of the locking or superlocking switch, to lock or superlock the latch electrically, preventing latch release by at least one of the external manual controls.

13. A latch arrangement substantially as described herein with reference to the accompanying drawings.

14. Closure control apparatus including a latch arrangement, substantially as described herein with reference to the accompanying drawings.

15. A motor vehicle with central locking, in which a plurality of doors are fitted with respective latch arrangements substantially as described herein with reference to the accompanying drawings.
